(19) United States
(12) Patent Application Publication
(10) Pub. No.: US 2022/0358497 A1
(43) Pub. Date: Nov. 10, 2022

(54) TAXI SYSTEM

(71) Applicant: TOYOTA JIDOSHA KABUSHIKI KAISHA, Toyota-shi (JP)

(72) Inventors: Makoto KAKUCHI, Toyota-shi (JP); Osamu IZUMIDA, Nagoya-shi (JP); Shunji INOUE, Okazaki-shi (JP); Takumi HAMAJIMA, Takatsuki-shi (JP); Mitsushi KINTAKA, Kariya-shi (JP); Toshihiro ANDOU, Kariya-shi (JP); Masamitsu TAKAHIRA, Kariya-shi (JP)

(21) Appl. No.: 17/662,754

(22) Filed: May 10, 2022

(30) Foreign Application Priority Data
May 10, 2021 (JP) 2021-080011

(51) Int. Cl. G06Q 20/38; G06Q 20/40; G06F 21/33; B60W 40/08; B60W 60/00; G05D 1/02

(52) U.S. Cl. CPC G06Q 20/38215; G06Q 20/4014; G06F 21/33; B60W 40/08; B60W 60/00253; G05D 1/0287; B60W 2540/043; G05D 2201/0213

(57) ABSTRACT

A taxi system includes: a plurality of unmanned taxi vehicles; a medium reader that is mounted on the unmanned taxi vehicle, and outputs a result obtained by reading a certificate medium presented by the occupant, as read data; and a system controller that acquires, by analyzing the read data, ticket information including at least one of a destination and payment information, and executes, based on the acquired ticket information, at least one of setting of the destination of the unmanned taxi vehicle and execution of a payment, in which the certificate medium is a medium issued to the occupant in order to authenticate the occupant in a situation other than taxi use.

### CROSS REFERENCE TO RELATED APPLICATION

This application claims priority to Japanese Patent Application No. 2021-080011 filed on May 10, 2021, which is incorporated herein by reference in its entirety including the specification, claims, drawings, and abstract.

### TECHNICAL FIELD

The present specification discloses a taxi system including a plurality of unmanned taxi vehicles that each transport an occupant to a destination by unmanned driving.

### BACKGROUND

In recent years, it has been proposed to use a self-driving vehicle capable of automatic driving as a taxi vehicle. For example, PATENT LITERATURE 1 discloses a technique to provide a taxi service using a self-driving vehicle. Using the self-driving vehicle in this manner can implement an unmanned taxi vehicle in which no driver rides.

### CITATION LIST

PATENT LITERATURE 1: JP 2017-174208 A

Meanwhile, naturally, no driver rides in an unmanned taxi vehicle. Therefore, an occupant who uses the unmanned taxi vehicle normally needs to execute setting of a destination and payment processing by operating an information terminal, or a user interface device mounted on the unmanned taxi vehicle. However, some occupants cannot appropriately operate such an information device. For example, an elderly person, a child, a drunken person, and the like cannot appropriately operate the information device in many cases. As a result, there has been a possibility that the elderly person and the like cannot freely use the unmanned taxi vehicle. Moreover, even for a person who can appropriately operate the information device, the above-mentioned setting operation of a destination, and payment operation, have been cumbersome.

Therefore, the present specification discloses a taxi system that can be used more easily by many people.

### SUMMARY

The present specification discloses a taxi system including: a plurality of unmanned taxi vehicles that each transport an occupant to a destination by unmanned driving; a medium reader that is mounted on the unmanned taxi vehicle, and outputs a result obtained by reading a certificate medium presented by the occupant, as read data; and a system controller that acquires, by analyzing the read data, ticket information including at least one of a destination and payment information, and executes, based on the acquired ticket information, at least one of setting of the destination of the unmanned taxi vehicle and execution of a payment, in which the certificate medium is a medium issued to the occupant in order to authenticate the occupant in a situation other than taxi use.

With such a configuration, the occupant only presents the certificate medium that is owned by the occupant to complete at least one of the setting of the destination and the payment processing, so that the occupant can use the unmanned taxi vehicle more easily.

In this case, the taxi system further includes a medium DB in which an identification characteristic for specifying a type of the certificate medium and format information indicating a format of the certificate medium are stored in association with each other, for each type of the certificate medium, and the system controller may extract the identification characteristic from the read data, specify, by verifying the extracted identification characteristic against the medium DB, the format information on the presented certificate medium, and analyze the read data based on the specified format information.

With such a configuration, the system controller can grasp the contents recorded in the various types of certificate media. Accordingly, the taxi system can use the various types of certificate media as taxi tickets.

Moreover, the taxi system further includes a ticket DB in which individual identification information for identifying an individual of the certificate medium and the ticket information are stored in association with each other, and the format information may include at least information indicating arrangement of the individual identification information in the read data, and the system controller may extract the individual identification information from the read data based on the specified format information, and acquire, by verifying the extracted individual identification information against the ticket DB, the ticket information associated with the presented certificate medium.

With such a configuration, ticket information that is desired by a user can be allocated for each certificate medium. As a result, the convenience to the user can be further increased.

Moreover, the ticket information further includes a use condition including at least one of a time condition, a position condition, and a human condition when the taxi vehicle is used, and the system controller, when the use condition included in the acquired ticket information is not coincident with an actual use condition, may execute neither the setting of the destination nor the payment processing based on the certificate medium.

With such a configuration, improper use of the certificate medium can be effectively prevented.

Moreover, the system controller may, when the acquired ticket information includes one or more contact addresses, notify the contact address of a transport status of the occupant that is conducted by receiving the presentation of the certificate medium.

With such a configuration, a person involved with the occupant can grasp the transport status of the occupant, so that the sense of security of the person involved can be further increased.

Moreover, one or more items of position information are recorded in the certificate medium, and the system controller may extract the position information from the read data as the ticket information based on the specified format information, and set the destination based on the extracted position information.

With such a configuration, the ticket information corresponding to the certificate medium does not need to be registered in advance, so that the occupant can use the unmanned taxi vehicle more freely.

Moreover, the system controller may, when the acquired ticket information includes two or more destinations, present the two or more destinations to the occupant as destination candidates, and set the destination candidate selected by the occupant as the destination of the unmanned taxi vehicle.

With such a configuration, the convenience to the occupant can be further increased.

Moreover, the medium reader may include at least one among a camera that images the certificate medium, a scanner that scans a surface of the certificate medium, a bar code reader that reads a bar code assigned to the certificate medium, and an IC reader that reads data recorded in an IC chip built into the certificate medium.

With the taxi system that is disclosed in the present specification, many people can use the unmanned taxi vehicles more easily.

### BRIEF DESCRIPTION OF DRAWINGS

Embodiment(s) of the present disclosure will be described based on the following figures, wherein:

FIG. 1 is an conceptual diagram of a taxi system;

FIG. 2 is a block diagram illustrating a configuration of the taxi system;

FIG. 3 is a diagram illustrating one example of a configuration of a medium DB;

FIG. 4 illustrates diagrams of one example of a driver's license that is one type of certificate medium, and a format thereof;

FIG. 5 illustrates diagrams of one example of a patient's registration card that is one type of certificate medium, and a format thereof;

FIG. 6 is a diagram illustrating one example of a configuration of a ticket DB;

FIG. 7 is a diagram illustrating a flow of processing of a system controller in a case where the certificate medium is used as a taxi ticket;

FIG. 8 is a diagram illustrating one example of a destination selection screen that is presented to an occupant via a UI device; and

FIG. 9 is a diagram illustrating another flow of the processing of the system controller in the case where the certificate medium is used as a taxi ticket.

### DESCRIPTION OF EMBODIMENTS

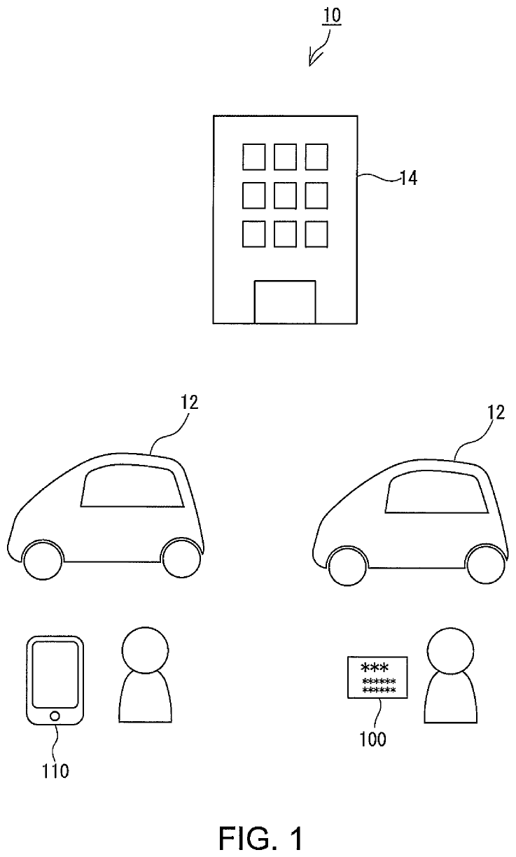

Hereinafter, a configuration of a taxi system 10 will be described with reference to the drawings. FIG. 1 is an conceptual diagram of the taxi system 10. As illustrated in FIG. 1, the taxi system 10 is provided with a plurality of taxi vehicles 12, and a management center 14 that manages these taxi vehicles 12.

The taxi vehicle 12 is a vehicle that receives a request from an occupant, and transports the occupant to a destination under an individual contract. The taxi vehicle 12 in this example is a single-passenger vehicle with a seating capacity of one. Note that, naturally, an infant or the like is not counted as an occupant, and can ride with an adult. Moreover, the taxi vehicle 12 is a self-driving vehicle in which all dynamic driving tasks are conducted by the vehicle. Accordingly, no driver rides in the taxi vehicle 12.

Note that “automatic driving” indicates that the vehicle conducts almost all dynamic driving tasks, and indicates, for example, any of levels 3 to 5 defined by the Society of Automotive Engineers in the USA. The level 3 is a driving mode in which all the dynamic driving tasks are automated in a specified location such as a superhighway, but an operation by a driver becomes necessary in case of emergency. Moreover, the level 4 is a driving mode in which all the dynamic driving tasks are automated only at a specified location, and measures in case of emergency are automatically processed. The level 5 is a driving mode in which automatic driving is possible under almost all conditions without limitations of a location and the like, and indicates so-called “perfect automatic driving”.

The management center 14 manages allocation of the taxi vehicles 12. Specifically, the management center 14 collects and manages a position and a service state of each of the plurality of the taxi vehicles 12. Here, examples of the service states of the taxi vehicle 12 include empty, running-on-hire, out-of-service, and pick-up. Moreover, the management center 14 calculates arrangement of the taxi vehicles 12 by considering a request from a user, distribution statuses of the taxi vehicles 12 and persons in town, and the like, and outputs allocation instructions to the taxi vehicles 12. The taxi vehicle 12 travels as appropriate in accordance with the allocation instruction.

Here, as mentioned above, no driver rides in the taxi vehicle 12. Therefore, the occupant normally needs to set a destination and execute a payment by operating an information terminal 110 (for example, a smartphone) that is owned by the occupant or a user interface device (hereinafter, referred to as a “UI device”) that is mounted on the taxi vehicle 12. However, some occupants cannot appropriately conduct the operation of such an information device. For example, an elderly person and a child are unaccustomed to the operation of the information device, and cannot appropriately operate the information device in many cases. Moreover, even a person who can appropriately operate the information device in normal times cannot appropriately operate the information device due to the effects of drinking or illness, in some cases. In addition, even for a person who can appropriately operate the information device, the setting operation of a destination and the like is cumbersome and troublesome work. In particular, there is a request that a location, such as one's home, which will often be set as a destination of the taxi vehicle 12, should be easily set as a destination without operating the information device.

Therefore, the taxi system 10 in this example executes, based on a certificate medium 100 owned in advance by the occupant, at least one of setting of a destination and execution of a payment. Specifically, the management center 14 stores in advance the certificate medium 100 in association with ticket information. The ticket information is information necessary when the taxi vehicle 12 is used, and includes at least one of a destination and payment information. The taxi vehicle 12 reads the certificate medium 100 presented by the occupant, and transmits a read result to the management center 14. The management center 14 verifies information stored in advance against information transmitted from the taxi vehicle 12, specifies ticket information associated with the certificate medium 100, and transmits the ticket information to the taxi vehicle 12. The taxi vehicle 12 executes the setting of the destination and the like based on the ticket information transmitted from the management center 14. In other words, in the taxi system 10 in this example, the certificate medium 100 held by the occupant can also be used as a “taxi ticket” that is presented when the taxi vehicle 12 is used. Hereinafter, a specific configuration for implementing such processing will be described.

Firstly, the certificate medium 100 that is used in the present system will be described. The certificate medium 100 is already owned by an occupant, and is a certificate that can be physically carried. Accordingly, the certificate medium 100 may have, for example, a card form or a pocket notebook form. Moreover, the certificate medium 100 is a certificate issued by an organization, a party, or an individual other than the taxi system 10, in order to authenticate the occupant in a situation other than taxi use. Accordingly, the certificate medium 100 may be, for example, a driver's license, a My-number card, a passport, a student identification card, an employee ID card, a patient's registration card, or a membership card. Moreover, the taxi system 10 in this example deals with several types of certificate media 100. Accordingly, for example, the taxi system 10 may store a driver's license owned by a specified occupant in association with a home of the specified occupant, and may store a patient's registration card owned by the specified occupant in association with an address of the medical treatment facility. In this case, the taxi vehicle 12, in a case where the occupant presents the driver's license, sets the home of the occupant as a destination, and, in a case where the occupant presents the patient's registration card, sets the address of the medical treatment facility as a destination.

Moreover, in the certificate medium 100, information related to the certificate medium 100 and an owner thereof (hereinafter, referred to as “certificate information”) is recorded. For example, on the surface of a driver's license, there are printed a name and an address of the owner, a type of the vehicle they are permitted drive, a face photograph, an expiration date, a license number, a name of the issuing institution, and the like, as certificate information, which are slightly different depending on countries. Moreover, in a patient's registration card, normally recorded are a name, an address, and a telephone number of the medical treatment facility, a registration number of the owner, a name of the owner, and the like, as certificate information, which are different depending on medical treatment facilities that have issued the patient's registration cards. Such certificate information may be printed on the surface of the certificate medium 100 as text, or may be printed as a bar code or the like in an enciphered state. Moreover, as another form, certificate information may be recorded in an IC chip built into the certificate medium 100.

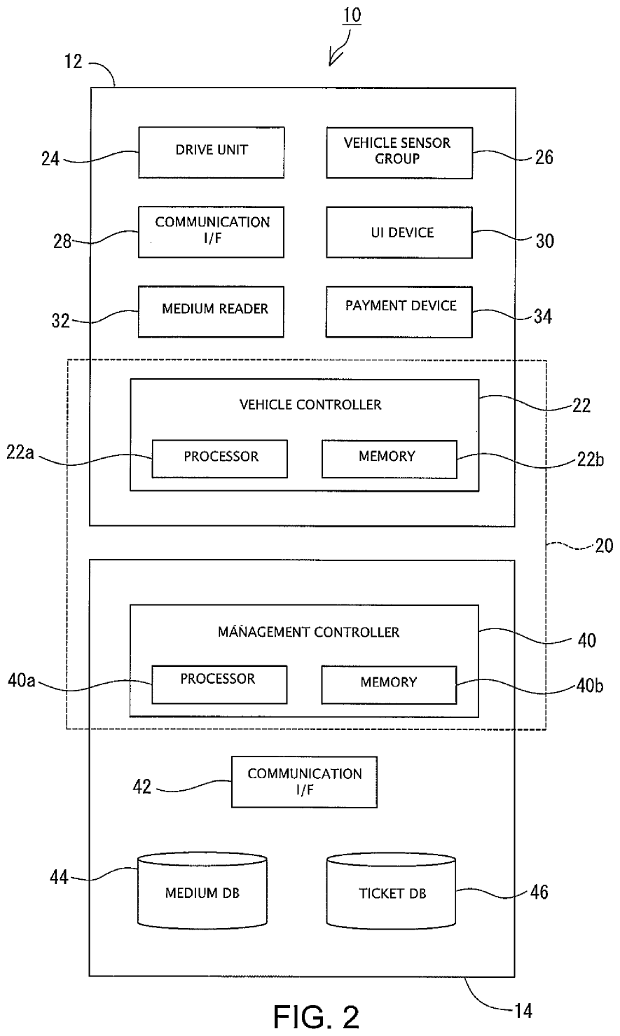

Next, with reference to FIG. 2, configurations of the taxi vehicle 12 and the management center 14 will be described. FIG. 2 is a block diagram illustrating a configuration of the taxi system 10. As illustrated in FIG. 2, the taxi vehicle 12 includes a drive unit 24, a vehicle sensor group 26, a communication I/F 28, a UI device 30, a medium reader 32, a payment device 34, and a vehicle controller 22. The drive unit 24 is a device that generates a mechanical driving force for causing the taxi vehicle 12 to travel, and includes a prime mover and a power transmission device, a brake device, a suspension device, and a steering device, for example. The vehicle sensor group 26 includes a plurality of sensors for sensing various kinds of information necessary for traveling of the taxi vehicle 12. Such a vehicle sensor group 26 includes, for example, a sensor (for example, a camera, an LiDAR, a millimeter-wave radar, or an ultrasound sensor) for detecting a surrounding environment of the taxi vehicle 12, a sensor (for example, a GPS) for detecting a current position of the taxi vehicle 12, or a sensor (for example, an acceleration sensor or a gyro sensor) for detecting a traveling state of the taxi vehicle 12. Information detected by the vehicle sensor group 26 is transmitted to the vehicle controller 22. The vehicle controller 22 computes an amount of acceleration and deceleration and a steering amount of the taxi vehicle 12 based on the information detected by the vehicle sensor group 26, and drives the drive unit 24.

The communication I/F 28 communicates with an information device outside the vehicle using a communication technique. In this case, examples of information devices to be communicated with include the management center 14, another taxi vehicles 12, and the information terminal 110 owned by an occupant. Such communication may be performed using mobile data communication provided by a mobile telephone company, may be performed using near field communication such as Bluetooth (registered trademark), or may be performed using a dedicated communication channel.

The UI device 30 is a device that presents information to a user, and receives an operation by the user. The UI device 30 includes, for example, an output device that outputs information to the user, and an input device that receives an operation by the user. The output device may include, for example, at least one among a display, a speaker, and a lamp. Moreover, the input device may include, for example, at least one among a touch panel, a key board, a switch, a lever, a pedal, and a microphone.

The medium reader 32 reads the certificate medium 100 presented by the occupant, and outputs a result thereof as read data. Such the medium reader 32 may include at least one among a camera that images the certificate medium 100, a scanner that scans the surface of the certificate medium 100, a bar code reader that reads a bar code assigned to the certificate medium 100, and an IC reader that reads data recorded in an IC chip built in the certificate medium 100, for example. In a case where the medium reader 32 includes the camera or the scanner, read data includes image data that is obtained by imaging or scanning the certificate medium 100. Moreover, in a case where the medium reader 32 includes the bar code reader, read data includes information that is obtained by analyzing the bar code. In addition, in a case where the medium reader 32 includes the IC reader, read data includes data read from the IC chip.

The payment device 34 is a device that executes collection of a usage fare of the taxi vehicle 12 alone or together with the management center 14. Accordingly, the payment device 34 may include a device for collecting usage fares, for example, a change machine that counts a monetary amount of dropped cash, and gives a user their change if necessary, a card reader that processes payment with a credit card, a RFID reader/writer that communicates with an IC chip built into a prepaid card, a bar code reader for executing bar code payment, and the like. Moreover, the payment device 34 may be a device that acquires access information (for example, identification information, a password, and the like of a user) for accessing an electronic wallet pre-registered by the user, and transmits the access information to the management center 14. In this case, the management center 14 accesses the electronic wallet of the user based on the received access information, and collects the usage fare. Moreover, as will be mentioned later, in a case where a debit account or a credit card number as payment information is associated with the certificate medium 100, the taxi system 10 automatically executes payment processing in accordance with the payment information. Accordingly, in this case, the occupant only presents the certificate medium 100, but does not need to operate the payment device 34.

The vehicle controller 22 controls driving of the taxi vehicle 12. The vehicle controller 22 grasps a surrounding environment of the taxi vehicle 12, for example, from detection results by the vehicle sensor group 26, and controls driving of the drive unit 24 so as to allow the taxi vehicle 12 to travel safely.

The vehicle controller 22 is physically a computer including a processor 22a and a memory 22b. The “computer” includes a micro controller in which a computer system is incorporated into one integrated circuit. Moreover, the processor 22a indicates a processor in a broad sense, and includes a general processor (for example, CPU: Central Processing Unit), and a dedicated processor (for example, GPU: Graphics Processing Unit, ASIC: Application Specific Integrated Circuit, FPGA: Field Programmable Gate Array, and a programmable logic device). Moreover, the processor 22a does not need to be physically one element, but may include a plurality of processors that are present in positions physically distant from one another. Similarly, the memory 22b also does not need to be physically one element, but may include a plurality of memories that are present in positions physically distant from one another. Moreover, the memory 22b may include at least one among a semiconductor memory (for example, a RAM, a ROM, and a solid state drive) and a magnetic disk (for example, a hard disk drive).

Next, a configuration of the management center 14 will be described. The management center 14 includes a management controller 40, a communication I/F 42, a medium DB 44, and a ticket DB 46. The communication I/F 42 communicates with the plurality of the taxi vehicles 12 via a general communication network or a dedicated communication network.

The medium DB 44 is a database that is referred to when a type of the certificate medium 100 and a format thereof are specified, and is described later in detail. Moreover, the ticket DB 46 is a database that is referred to when ticket information associated with the certificate medium 100 is specified. The specific configuration of the ticket DB 46 is also described later.

The management controller 40 controls allocation of the taxi vehicles 12 in response to a usage demand transmitted by a user via an external information terminal or the UI device 30 of the taxi vehicle 12. The usage demand is information that is transmitted when the user desires to use the taxi vehicle 12. The usage demand includes at least a destination. Moreover, when the user does not ride at a current time point but will rides at a later time, the usage demand further includes a ride position and a ride date/time. The management controller 40 outputs an allocation instruction to the taxi vehicle 12 based on such a usage demand, traveling states of the plurality of the taxi vehicles 12, distribution of persons in town, and the like. Such a management controller 40 is also configured as a computer including a processor 40a and a memory 40b.

Moreover, the management controller 40 and the vehicle controller 22 form a system controller 20. The system controller 20 executes at least one of destination setting of the taxi vehicle 12 and payment processing based on the certificate medium 100 presented by the occupant.

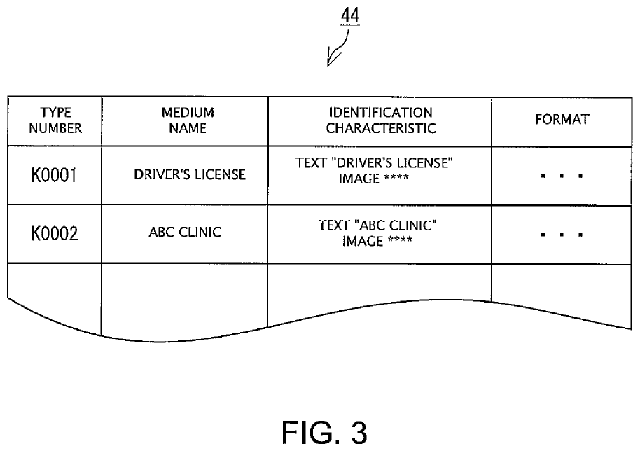

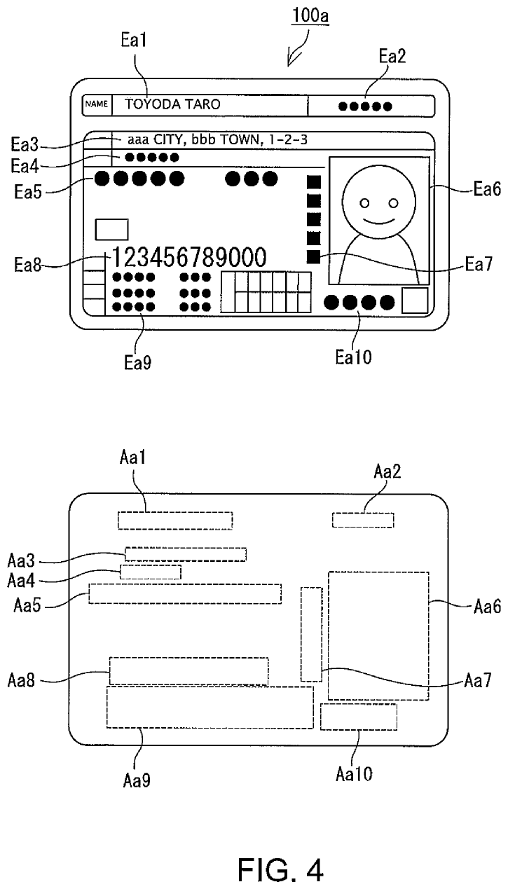

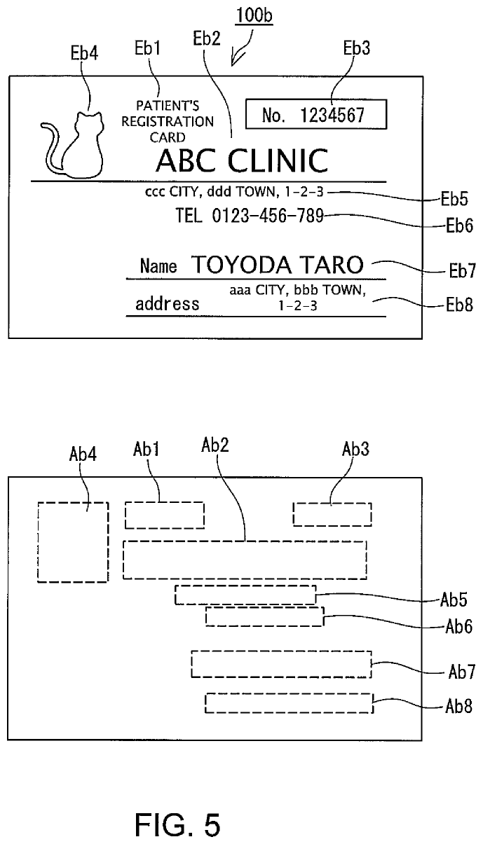

Next, a configuration of the medium DB 44 will be described with reference to FIGS. 3 to 5. FIG. 3 is a diagram illustrating one example of a configuration of the medium DB 44. FIG. 4 is diagrams of one example of a driver's license 100a that is one type of the certificate medium 100, and a format thereof. Moreover, FIG. 5 is diagrams of one example of a patient's registration card 100b that is one type of the certificate medium 100, and a format thereof.

As mentioned above, the taxi system 10 in this example executes the destination setting and the like of the taxi vehicle 12 based on the certificate medium 100. Moreover, the taxi system 10 can deal with several types of certificate media 100. The content of certificate information recorded in the certificate medium 100, the format of the recording, and the like, differ depending on the type of the certificate medium 100. Therefore, in order to extract certificate information recorded in the certificate medium 100 from read data that has been read by the medium reader 32, the type of the certificate medium 100 and a format thereof need to be grasped.

Therefore, the taxi system 10 includes the medium DB 44 in order to specify the type of the certificate medium 100 and the format. The medium DB 44 is a database in which a type number, a medium name, an identification characteristic, and format information of the certificate medium 100 are recorded in association with one another, as illustrated in FIG. 3. The type number is an identification number indicating the type of the certificate medium 100. In the illustrated example, type numbers of “K0001” and “K0002” are respectively set to the driver's license and the patient's registration card of “ABC clinic”.

The identification characteristic is a characteristic that is used when the type of the certificate medium 100 is specified. For example, in the certificate medium 100, normally, text indicating the type of the certificate medium 100 is recorded. The text indicating the type serves as an identification characteristic. For example, in a case of the driver's license 100a in Japan illustrated in FIG. 4, text Ea7 of the “driver's license” is assigned at the left side of a face image Ea6. A content, a font, a font size, a written position, and the like of the text of the “driver's license” are recorded in the medium DB 44 as the identification characteristics of the driver's license 100a. Moreover, the identification characteristic may include, in addition to such information related to the text indicating the name of the medium type, a specified image and text included in the driver's license 100a.

Similarly, in a case of the patient's registration card 100b of the “ABC clinic” illustrated in FIG. 5, text Eb2 of “ABC clinic” is assigned to an upper portion. The text, a font, a font size, a written position, and the like of the “ABC clinic” are recorded in the medium DB 44 as the identification characteristics of the patient's registration card 100b. Moreover, the identification characteristic may include, in addition to such information related to the text indicating the name of the medium type, a specified image included in the patient's registration card 100b, for example, in the example of FIG. 5, an image Eb4 of a cat, and information thereon such as a position thereof.

The management controller 40 analyzes the read data acquired by the medium reader 32, and determines the presence or absence of the identification characteristic. Further, if the specified identification characteristic is present, the management controller 40 determines that the type of the read certificate medium 100 is a type corresponding to the specified identification characteristic. For example, in a case where the text of the “ABC clinic” and the image of the prescribed cat are included in the read data, the management controller 40 determines that the type of the read certificate medium 100 is the patient's registration card 100b having the type ID of “K0002”.

In the medium DB 44, format information in association with the type number is further recorded. The format information is information indicating a format of the certificate information recorded in the certificate medium 100. For example, in the case of the driver's license 100a in Japan illustrated in FIG. 4, certificate information is recorded in accordance with the prescribed format, for example, a name Ea1 is recorded in an area Aa1, a birth date Ea2 in an area Aa2, an address Ea3 in an area Aa3, and a license number Ea8 in an area Aa8.

Similarly, in the case of the patient's registration card 100b illustrated in FIG. 5, certificate information is recorded in accordance with the prescribed format, for example, a name Eb2 of the medical treatment facility is recorded in an area Ab2, a registration number Eb3 in an area Ab3, a facility address Eb5 in an area Ab5, a facility telephone number Eb6 in an area Ab6, and a name of a person themself Eb7 in an area Ab7. In the medium DB 44, information indicating such the format of the certificate medium 100, for example, coordinates of each area, and the type of information to be recorded are recorded. The management controller 40 analyzes the read data based on the format information, and acquires certificate information on the certificate medium 100.

Note that the format information exemplified herein is one example. The form of format information may be changed as appropriate as long as the format information includes at least arrangement of individual identification information for identifying an individual of the certificate medium 100. For example, the license number Ea8 serves as individual identification information in the case of the driver's license 100a, and the registration number Eb3 serves as individual identification information in the case of the patient's registration card 100b. Accordingly, the other forms of the format information may be changed as appropriate as long as the format information includes information in which the license number Ea8 is recorded in the area Aa8, and the registration number Eb3 is recorded in the area Ab3.

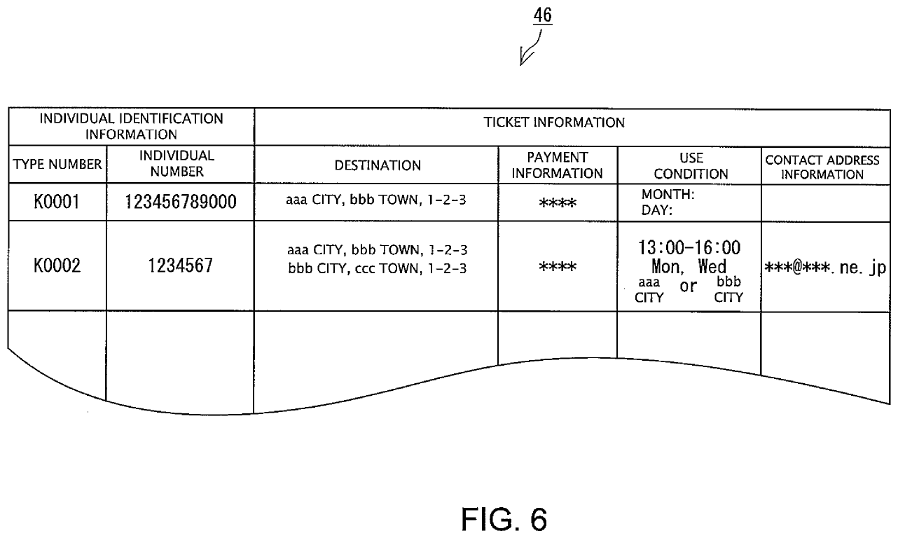

Next, the ticket DB 46 will be described with reference to FIG. 6. The ticket DB 46 is a database in which individual identification information on the certificate medium 100 and ticket information are recorded in association with each other. As is specifically described, in the ticket DB 46, as individual identification information, a type number and an individual number are recorded in association with each other. The type number is the same as the type number recorded in the medium DB 44, and is identification information indicating the type of the certificate medium 100. The individual number is identification information indicating an individual of the certificate medium 100. For example, in the case of the driver's license 100a in Japan illustrated in FIG. 4, the license number Ea8 that is different for each driver's license is assigned. Accordingly, in the case of the driver's license 100a, the license number Ea8 is registered as an individual number for identifying an individual of the driver's license 100a. Similarly, in the case of the patient's registration card 100b illustrated in FIG. 5, the registration number Eb3 is registered as an individual number for identifying an individual of the patient's registration card 100b. Further, a combination of the type number and the individual number of the certificate medium 100 serves as individual identification information for identifying an individual of the certificate medium 100.

In the ticket DB 46, ticket information is further recorded. The ticket information is information including at least one of a destination and payment information. The destination may be an address including a place name and a house number, or may be a latitude and a longitude indicating a position, as long as the destination is information capable of specifying a position. Moreover, as another form, the destination may be a unique name, a telephone number, or the like, of the facility. Moreover, the position registered as destination information is not limited to one place but may be a plurality of places.

The payment information is information necessary for payment of a usage fare of the taxi vehicle 12. Examples of such payment information include a debit account number for the fare, a credit card number, and an ID number of electronic money.

The ticket information may further include a use condition. The use condition is a condition when an owner of the corresponding certificate medium 100 uses the taxi vehicle 12. The use condition may include at least one among a time condition, a position condition, and a human condition, for example. The time condition includes a date/time, a day of the week, a season, and the like when the taxi vehicle 12 is used. Moreover, the position condition includes, for example, an area and the like in which an occupant gets in the taxi vehicle 12. In addition, the human condition includes an attribute of the occupant who has the corresponding certificate medium 100, for example, gender and age. The management controller 40 does not execute setting of a destination and payment processing based on the certificate medium 100 when the use condition recorded in the ticket DB 46 is not coincident with an actual use condition of the taxi vehicle 12, which is described later.

The ticket information may further include contact address information. The contact address information is information indicating a contact address of a status of transport for an occupant that is executed by receiving the presentation of the certificate medium 100. Examples of such contact address information include a mail address, a destination of a short message (in other words, a telephone number), and an ID of an instant messenger. In a case where the transport of the occupant is executed by receiving the presentation of the certificate medium 100, the system controller 20 notifies the contact address of a status thereof. Note that the contact address is not limited to one contact address but a plurality of contact addresses may be registered.

An occupant or a substitute for the occupant operates the external information terminal or the UI device 30 of the taxi vehicle 12 to register such information on the ticket DB 46. Specifically, a person who desires to register the ticket information operates the external information terminal or the UI device 30 to transmit read data on the certificate medium 100 that is desired to be registered, and ticket information that is desired to be associated with the certificate medium 100, to the management center 14.

For example, in a case where the management controller 40 has received a registration request for ticket information from a person who desires registration, the management controller 40 demands transmission of read data (for example, an imaged image) on the certificate medium 100 of the person who desires registration. Upon the reception of the demand, when the person who desires registration transmits read data, the management controller 40 verifies the read data against the medium DB 44, and extracts certificate information (a name, a registration number, and the like) recorded in the certificate medium. Further, the management controller 40 transmits the acquired certificate information to the person who desires registration, and the correctness is checked. As a result of the check, if no error is present in the extracted certificate information, the management controller 40 subsequently demands an input of ticket information to be associated with the certificate medium 100 of the person who desires registration. Upon the reception of the demand, the person who desires registration transmits the ticket information to the management controller 40. The management controller 40 records the received ticket information in association with identification information (the type number and the individual number) on the certificate medium 100, in the ticket DB 46. For such registration of the ticket information, the person who desires registration may install a dedicated application on the information terminal that is owned by the person, or may access a home page that is run by the taxi system 10.

Here, such a registration operation of the ticket information may be conducted by the owner of the certificate medium 100, or may be conducted by a substitute for the owner. In other words, as mentioned above, an elderly person and a child are unaccustomed to operating the information terminal, and thus cannot appropriately conduct the above-mentioned registration of ticket information in some cases. In such a case, a substitute for the owner of the certificate medium 100, for example, a family member or an acquaintance of the owner may register ticket information, in place of the owner. In any case, identification information on the certificate medium 100 and ticket information are recorded in the ticket DB 46 in association with each other, whereby the certificate medium 100 can be used as a taxi ticket indicating at least one of a destination and payment information.

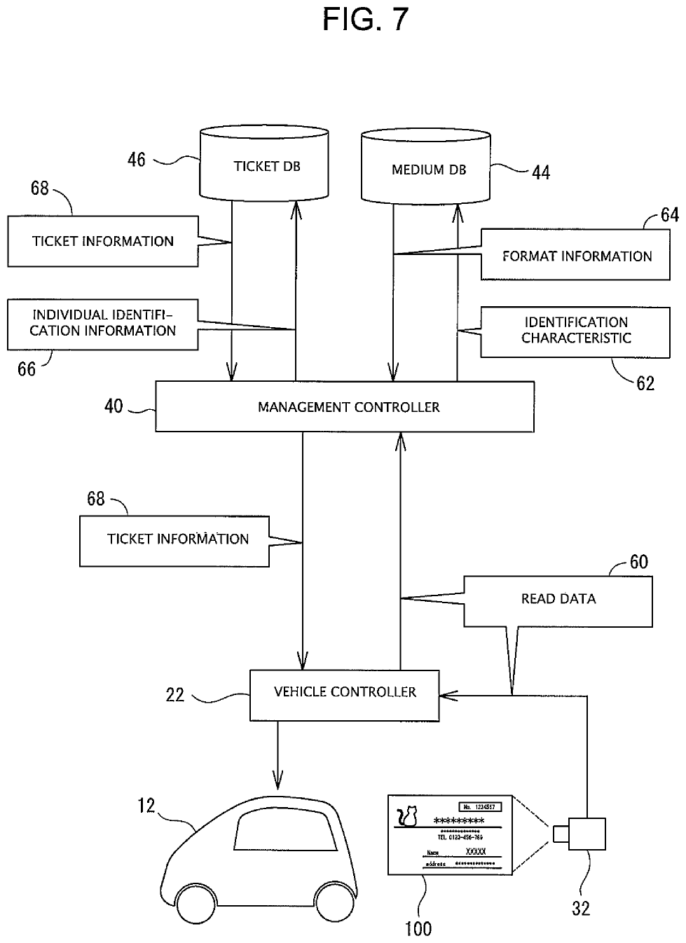

Next, processing by the system controller 20 in a case where the certificate medium 100 is used as a taxi ticket will be described with reference to FIG. 7. An occupant who wants to use the taxi vehicle 12 presents the certificate medium 100 that is owned by the occupant when the occupant has got on the taxi vehicle 12. The medium reader 32 reads the presented certificate medium 100, and outputs a read result thereof as read data 60, to the vehicle controller 22. The vehicle controller 22 transmits the acquired read data 60 to the management controller 40. The management controller 40 refers to medium DB 44 to analyze the read data, and thus specifies a type and a format of the certificate medium 100 presented by the occupant.

Specifically, the management controller 40 searches for an identification characteristic 62 in the read data 60. For example, in a case where the read data is an image obtained by imaging the certificate medium 100, the management controller 40 may subject the image to optical character recognition (OCR), and as a result of the OCR, search for the presence or absence of text that is set as the identification characteristic 62, in the acquired text. Moreover, as another form, in a case where a prescribed image is set as the identification characteristic 62, the management controller 40 may determine whether the prescribed image is included in the read data (in other words, the imaged image) by pattern matching processing. In any case, the management controller 40 determines a type corresponding to the identification characteristic 62 included in the read data as the type of the certificate medium 100 presented by the occupant. Further, if a medium type can be specified, the management controller 40 verifies the medium type that has been capable of being specified against the medium DB 44, and acquires corresponding format information 64.

If the format information 64 is acquired, the management controller 40 analyzes the read data 60 based on the format information 64, and extracts certificate information from the read data 60. Examples of the certificate information include an individual number of the certificate medium 100, a name and an address of the owner of the certificate medium 100, and a name and an address of a facility in which the certificate medium 100 is used. If such certificate information is acquired, the management controller 40 verifies individual identification information 66 that is a combination of the acquired individual number and the type number of the certificate medium 100 against the ticket DB 46, and acquires ticket information 68 associated with the presented certificate medium 100.

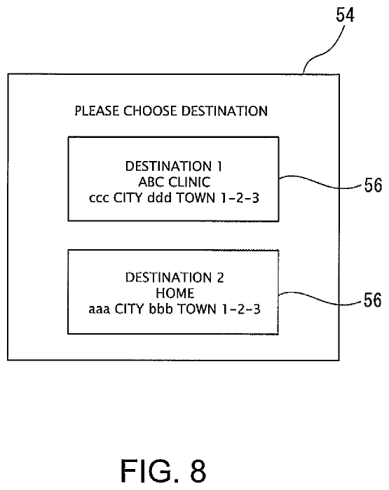

If the ticket information 68 is acquired, the management controller 40 transmits the ticket information 68 to the vehicle controller 22. The vehicle controller 22 executes at least one of the destination setting of the taxi vehicle 12 and the payment processing based on the received ticket information 68. In other words, in a case where a destination is included in the ticket information, the vehicle controller 22 sets the destination included in the ticket information as a destination of the taxi vehicle 12. Note that in a case where two or more destinations are included in the ticket information, the vehicle controller 22 presents the two or more destinations as destination candidates to the occupant via the UI device 30. FIG. 8 is a diagram illustrating one example of a destination selection screen 54 that is presented to the occupant via the UI device 30. In a case where the ticket information includes “ABC clinic: ccc City ddd Town 1-2-3” as a destination 1, and “Home: aaa City bbb Town 1-2-3” as a destination 2, the vehicle controller 22 presents the destination selection screen 54 illustrated in FIG. 8 to the occupant via the UI device 30. The occupant selects a desired destination from the two presented destination candidates 56. The vehicle controller 22 sets the destination candidate 56 selected by the occupant as a destination of the taxi vehicle 12.

Moreover, in a case where the ticket information includes payment information, the vehicle controller 22 executes payment processing in accordance with the payment information. For example, in a case where a prescribed debit account is set as payment information, the vehicle controller 22 debits a usage fare of the taxi vehicle 12 from the debit account.

Moreover, in a case where the ticket information includes a use condition, the vehicle controller 22 checks whether an actual use condition for taxi vehicle 12 is coincident with the use condition set in the ticket information. Further, if the actual use condition is not coincident with the set use condition, the vehicle controller 22 executes neither setting of a destination nor payment processing based on the certificate medium 100, and notifies the occupant of the fact.

Moreover, in a case where the ticket information includes contact address information, the vehicle controller 22 notifies a contact address registered in the contact address information of a transport status of the occupant. With such a configuration, a sense of security for a person who receives the notification of the transport status can be improved, and if an abnormality occurs with respect to the occupant, a measure against the abnormality can be taken at an early stage. For example, a case is considered where, in association with a membership card of a cram school which a child attends, both of an address (destination) of the cram school and a mail address (contact address information) of parents of the child are recorded in the ticket DB 46. In this case, when the child presents the membership card of the cram school, the taxi vehicle 12 transports the child to the cram school. Moreover, in this case, the taxi vehicle 12 transmits a transport status of the child to the mail address of the parents of the child. Upon the reception of the notification, the parents can grasp the status of the child at a remote location, and can thus obtain a high sense of security. Moreover, if an unexpected status has occurred, for example, in a case where the transport is not started at the time when the transport to the cram school was to be originally started, and other cases, the parents can notice the occurrence of the abnormality at an early stage, and thus can take a suitable measure at an early stage.

As will be apparent from the description in the foregoing, with the present example, when the occupant presents the certificate medium 100, the destination setting and/or the payment processing can be automatically executed. As a result, even an elderly person, a child, a drunken person, or the like who has difficulty appropriately operating the information device can easily use the taxi vehicle 12. Moreover, even a person who can appropriately operate the information device can use the taxi vehicle 12 with a simple operation of presenting the certificate medium 100, if they have registered the certificate medium 100 (for example the driver's license 100a) that is owned by the person and a place (for example, a home) with a high movement frequency in association with each other, so that the convenience of the taxi vehicle 12 is further improved.

Meanwhile, in this example, the certificate medium 100 issued to the occupant in order to authenticate the occupant in a situation other than taxi use is used as a taxi ticket. However, without using such a certificate medium 100, it can also be considered that the taxi system 10 issues a dedicated taxi ticket. However, in the case where a taxi ticket that cannot be used in a case other than the taxi use has been issued, the occupant carries extra types of media, so that there is a problem in that using the different media depending on situations becomes troublesome. On the other hand, a function as a taxi ticket is assigned to the certificate medium 100, whereby the types of media that are carried by the occupant can be reduced, and the different media can be easily used depending on situations.

Moreover, many people each carry some sort of the certificate medium 100 in a wallet or the like all the time in order to authenticate themself. For example, the driver's license can be used as a certificate for themself in various situations, so that a person who has a driver's license carries the driver's license in a wallet or the like all the time in many cases. In this manner, a function as a taxi ticket is assigned to the certificate medium 100 that is carried by a person all the time, whereby occurrence of such a problem that a person cannot use a taxi because they have forgotten to bring the taxi ticket can be effectively prevented.

Moreover, some certificate media 100 are issued for the use of specified facilities. For example, a patient's registration card is issued for a patient to use a medical treatment facility having issued the patient's registration card. With the taxi system 10 in this example, as a destination to be associated with the certificate medium 100 that is used in such a specified facility, the address of the specified facility can be registered. Further, with such a registration, the occupant can easily use the different types of the certificate media 100 in accordance with the destinations. For example, with the taxi system 10 in this example, an address of a first medical treatment facility and an address of a second medical treatment facility can be recorded respectively in association with a patient's registration card of the first medical treatment facility and a patient's registration card of the second medical treatment facility. In this case, when the occupant wants to receive treatment in the first medical treatment facility and presents the patient's registration card of the first medical treatment facility to the taxi vehicle 12, the occupant can be moved to the first medical treatment facility, and when the occupant wants to receive treatment in the second medical treatment facility and presents the patient's registration card of the second medical treatment facility to the taxi vehicle 12, the occupant can be moved to the second medical treatment facility. In other words, in this case, the occupant only presents the patient's registration card of the medical treatment facility where the occupant wants to receive treatment to the taxi vehicle 12, and can be moved to the medical treatment facility, so that the occupant can intuitively use the different patient's registration cards (the certificate media 100).

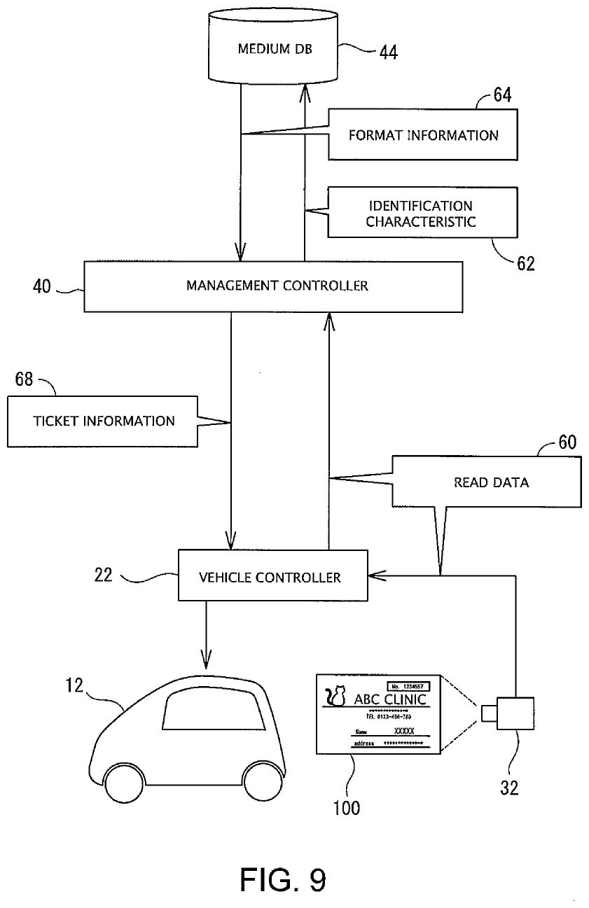

Next, processing in another taxi system 10 will be described with reference to FIG. 9. In the above-mentioned taxi system 10, an occupant or a substitute for the occupant operates the information terminal to register in advance ticket information corresponding to the certificate medium 100 in the ticket DB 46. In the taxi system 10 in FIG. 9, ticket information is not registered in advance, but is specified from certificate information recorded in the certificate medium 100. In other words, in the certificate medium 100, a home address of the owner or an address of a facility in which the certificate medium 100 is used, or both, are recorded in many cases. In this case, the system controller 20 automatically sets the home address or the facility address recorded in the certificate medium 100 as a destination of the taxi vehicle 12.

In other words, the vehicle controller 22 having received the read data 60 of the certificate medium 100 from the medium reader 32 transmits the read data 60 to the management controller 40. The management controller 40 verifies the read data 60 against the medium DB 44, and acquires the format information 64 on the certificate medium 100 presented by the occupant. Further, the management controller 40 having received the format information 64 extracts, based on the format information 64, the home address of the occupant or the facility address, or both, from the read data 60. The management controller 40 treats the address information extracted herein as a destination, and eventually, as the ticket information 68. Further, if the address information can be extracted, the management controller 40 transmits the ticket information 68, in which the extracted address information is set as a destination, to the vehicle controller 22. The vehicle controller 22 sets the destination included in the ticket information 68 as a destination of the taxi vehicle 12. Moreover, in a case where both of the home address and the facility address has been received, the vehicle controller 22 presents these two addresses as the destination candidates 56 to the occupant, and sets the destination candidate 56 selected by the occupant as a destination of the taxi vehicle 12.

As in the foregoing, in this example, position information on a destination is directly extracted from the certificate medium 100. With such a configuration, a prior operation for making the certificate medium 100 correspond to the ticket information becomes unnecessary, so that the occupant can use the taxi vehicle 12 more easily.

Note that the configuration described in the foregoing is one example, and as long as the system controller 20 acquires, by analyzing read data on the certificate medium 100, ticket information including at least one of a destination and payment information, and executes, based on the acquired ticket information, at least one of setting of the destination of the taxi vehicle 12 and execution of a payment, the other configurations may be changed. For example, in the description in the foregoing, the management controller 40 analyzes read data, but the vehicle controller 22 may analyze a part or all of the read data. Moreover, in place of the management center 14, the taxi vehicle 12 may include the medium DB 44 and the ticket DB 46. In addition, in the description in the foregoing, the taxi vehicle 12 is a single-passenger vehicle, but a plurality of persons can ride in the taxi vehicle 12 at the same time.

### REFERENCE SIGNS LIST

10 taxi system, 12 taxi vehicle, 14 management center, 20 system controller, 22 vehicle controller, 24 drive unit, 26 vehicle sensor group, 28 communication I/F, 30 UI device, 32 medium reader, 34 payment device, 40 management controller, 42 communication I/F, 44 medium DB, 46 ticket DB, 54 destination selection screen, 56 destination candidate, 60 read data, 62 identification characteristic, 64 format information, 66 individual identification information, 68 ticket information, 100 certificate medium, 110 information terminal.

1. A taxi system comprising:
a plurality of unmanned taxi vehicles that each transport an occupant to a destination by unmanned driving;
a medium reader that is mounted on the unmanned taxi vehicle, and outputs a result obtained by reading a certificate medium presented by the occupant, as read data; and
a system controller that acquires, by analyzing the read data, ticket information including at least one of a destination and payment information, and executes, based on the acquired ticket information, at least one of setting of the destination of the unmanned taxi vehicle and execution of a payment, wherein
the certificate medium is a medium issued to the occupant in order to authenticate the occupant in a situation other than taxi use.

2. The taxi system according to claim 1, further comprising a medium DB in which an identification characteristic for specifying a type of the certificate medium and format information indicating a format of the certificate medium are stored in association with each other, for each type of the certificate medium, wherein
the system controller extracts the identification characteristic from the read data, specifies, by verifying the extracted identification characteristic against the medium DB, the format information on the presented certificate medium, and analyzes the read data based on the specified format information.

3. The taxi system according to claim 2, further comprising a ticket DB in which individual identification information for identifying an individual of the certificate medium, and the ticket information, are stored in association with each other, wherein
the format information includes at least information indicating arrangement of the individual identification information in the read data, and
the system controller extracts the individual identification information from the read data based on the specified format information, and acquires, by verifying the extracted individual identification information against the ticket DB, the ticket information associated with the presented certificate medium.

4. The taxi system according to claim 3, wherein
the ticket information further includes a use condition including at least one of a time condition, a position condition, and a human condition when the taxi vehicle is used, and
the system controller, when the use condition included in the acquired ticket information is not coincident with an actual use condition, executes neither the setting of the destination nor the payment processing based on the certificate medium.

5. The taxi system according to claim 3, wherein the system controller, when the acquired ticket information includes one or more contact addresses, notifies the contact address of a transport status of the occupant that is conducted by receiving the presentation of the certificate medium.

6. The taxi system according to claim 2, wherein
one or more items of position information are recorded in the certificate medium, and
the system controller extracts the position information from the read data as the ticket information based on the specified format information, and sets the destination based on the extracted position information.

7. The taxi system according to claim 1, wherein the system controller, when the acquired ticket information includes two or more the destinations, presents the two or more destinations to the occupant as destination candidates, and sets the destination candidate selected by the occupant as the destination of the unmanned taxi vehicle.

8. The taxi system according to claim 1, wherein the medium reader includes at least one among a camera that images the certificate medium, a scanner that scans a surface of the certificate medium, a bar code reader that reads a bar code assigned to the certificate medium, and an IC reader that reads data recorded in an IC chip built in the certificate medium.
